(19) United States
(12) Patent Application Publication
(10) Pub. No.: US 2012/0303705 A1
(43) Pub. Date: Nov. 29, 2012

(54) CONTENTS SIMULTANEOUS PLAYBACK TERMINAL, THE SAME SYSTEM AND METHOD THEREOF

(76) Inventors: Jung Hoon PARK, Incheon-si (KR); Yong Jeong, Seongnam-si (KR)

(21) Appl. No.: 13/289,866

(22) Filed: Nov. 4, 2011

(30) Foreign Application Priority Data
May 25, 2011 (KR) 10-2011-0049575

(51) Int. Cl. G06F 15/16

(52) U.S. Cl. 709/204

(57) ABSTRACT

The present invention relates to a contents simultaneous playback terminal, the same system and method thereof. The contents simultaneous playback terminal, system and method is capable of allowing both terminals to share and simultaneously replay contents in a one-to-one correspondence by identifying terminals through terminal information broadcast in a single wireless access point network environment and setting a sharing environment for simultaneous playback of the contents of both terminals, without requiring a complicated separate sharing procedure. In addition, the contents simultaneous playback terminal, system and method is capable of, when both terminals connected in a one-to-one correspondence share contents, streaming the contents from one terminal to the other terminal and receiving in the other terminal the streamed contents for simultaneous playback of the contents, thereby extinguishing the contents after the playback.

### CROSS-REFERENCE TO RELATED APPLICATION

This application claims the benefit of Korean Application No. 10-2011-0049575, filed on May 25, 2011, with the Korean Intellectual Property Office, the disclosure of which is incorporated herein by reference.

### BACKGROUND OF THE INVENTION

1. Field of the Invention

The present invention relates to a contents simultaneous playback terminal, the same system and method thereof, and more particularly, to a contents simultaneous playback terminal which is capable of identifying terminals through terminal information broadcast in a single wireless access point network environment, sharing contents with a neighboring terminal in a streaming manner, and allowing both terminals to simultaneously replay the contents in a one-to-one correspondence, and the same system and method thereof.

2. Description of the Related Art

In recent years, various types of portable electronic devices to allow users to conveniently enjoy a variety of contents, such as music, movie, moving pictures and the like, have been released and used.

Examples of such portable electronic devices may include personal contents playback devices such as portable multimedia players (PMPs) and MP3 players, smart phones or mobile terminals equipped with contents playback capabilities, etc.

It is common that the smart phones and the mobile terminals have functionality of usability of wireless networks.

However, in the related art, it was insufficient for a user who uses his/her smart phone or mobile terminal to enjoy contents stored therein to share the contents with another neighboring user.

For example, as shown in FIG. 1, in order for a user who stores contents in his/her terminal 40 to share the contents with another user, a Y plug 41 or the like was used to connect their respective earphones while watching the same screen together.

However, since the single same terminal has to be shared for enjoyment of contents, this method has a limitation in immersion of the users in contents enjoyment since a radius in which the users can be moved due to a viewing angle for watch of the same screen, a length of earphone line and so on.

Accordingly, to overcome such a limitation, a contents sharing structure has been in general use which allows users to share and playback contents in their respective terminal.

FIG. 2 is a view showing an example contents sharing system including computers 10 and 20 of users, which shows a general contents sharing structure frequently used for a messenger and communication 11 and 21. Here, in case of a mobile terminal, the user computers 10 and 20 may be assumed to be terminal storing contents.

In this case, a management server 30 to mediate between both terminals 10 and 20 is essentially used to share and simultaneously use the contents between both terminals 10 and 20.

The management server 30 includes a user database to manage user information and manages connection between both terminals 10 and 20 or connection information of both terminals 10 and 20.

Accordingly, since the users have to subscribe for such sharing service for use, access verification for membership subscription and service use is also essential.

However, this has several problems in allowing neighboring users to enjoy the same contents simultaneously.

For example, the contents sharing requires a procedure relatively complicated to be used for a simple purpose that the neighboring users enjoy contents owned by one of them, which may result in user's low convenience.

Such complication of sharing and simultaneous playback procedures may be a critical factor of avoidance of service use by users.

In addition, there is a limitation in providing the sharing service with all of sharing schemes of various types of terminals and contents and even neighboring terminals are hard to achieve correct playback synchronization due to a difference in speed and distance between networks used.

In addition, the management server requires its maintenance costs. In addition, since the sharing and simultaneous playback service cannot be used any longer if the service is stopped by a service provider, reliability and persistency of the service cannot be guaranteed.

Further, since the contents have to be transmitted to a receiving terminal via a network and a management server, a service provider who provides services using the management server has to consider any legal problem such as copyright infringement.

Therefore, there is a need for a method of sharing and simultaneously contents with ease through a procedure convenient for neighboring users.

### SUMMARY OF THE INVENTION

Accordingly, it is an object of the present invention to provide a contents simultaneous playback terminal which is capable of allowing both terminals to share and simultaneously replay contents in a one-to-one correspondence by identifying terminals through terminal information broadcast in a single wireless access point network environment and setting a sharing environment for simultaneous playback of the contents of both terminals, and the same system and method thereof.

It is another object of the present invention to provide a contents simultaneous playback terminal which is capable of simultaneously contents through a simple sharing procedure of identification of a network environment and search and selection of neighboring terminals, without a separate management server required for contents sharing and terminal identification.

It is still another object of the present invention to provide a contents simultaneous playback terminal which is capable of, when both terminals connected in a one-to-one correspondence share contents, streaming the contents from one terminal to the other terminal and receiving in the other terminal the streamed contents for simultaneous playback of the contents, thereby extinguishing the contents after the playback.

To achieve the above objects, according to an aspect of the invention, there is provided a contents simultaneous playback terminal which shares and simultaneously replays contents with a neighboring terminal in a single wireless access point network, including: a network identification unit which identifies an environment of the network; sharing terminal search unit which broadcasts its own information and searches neighboring terminals having the same configuration belonging to the network environment through the broadcast information according to the same scheme; a sharing environment setting unit which sets a sharing environment for simultaneous playback of the contents with the neighboring terminals, and requests one selected from the searched neighboring terminals to allow access to the selected neighboring terminal or allows the selected neighboring terminal to access the terminal; a playback information unit which manages playback information of the contents shared and replayed simultaneously with the selected neighboring terminal; a streaming unit which streams the shared contents to the selected neighboring terminal connected under the sharing environment; and a playback unit which streamingly receives the shared contents from the neighboring terminal connected under the sharing environment or replays the contents transmitted by the streaming unit.

Preferably, the sharing environment setting unit sets the sharing environment to be divided into a master mode and a slave mode, if the terminal is in the master mode, the streaming unit streams the shared contents to the neighboring terminal connected under the sharing environment, and if the terminal is in the slave mode, the playback unit streamingly receives and replays the shared contents from the neighboring terminal connected under the sharing environment.

Preferably, if the terminal is in the master mode, the sharing environment setting unit monopolizes rights of playback control of the contents to be simultaneously replayed.

Preferably, the playback information unit manages playback link information of the contents or a stored contents file as playback information of the contents.

Preferably, the playback information unit further includes and manages additional playback information of the contents, such as title, singer and playback time, as the playback information of the contents

Preferably, the sharing terminal search unit distinguishes one or more neighboring terminals belonging to the network environment based on IP addresses.

Preferably, the playback unit is implemented by a format of application.

Preferably, the sharing environment setting unit further includes a contents user interface to allow a user to select the shared contents.

Preferably, the shared contents are one of music, moving picture and movie.

According to another aspect of the invention, there is provided a contents simultaneous playback system which searches one or more neighboring terminals belonging to an environment of a single wireless access point network and shares and simultaneously replays contents with one selected from the searched neighboring terminals, including: first and second terminals which broadcast their own information, search neighboring terminals having the same configuration belonging to the network environment through the broadcast information according to the same scheme, set a sharing environment for simultaneous playback of the contents with the neighboring terminals, and request the selected neighboring terminal to allow access to the selected neighboring terminal or allows access of the selected neighboring terminal, wherein the first terminal manages playback information of the contents shared and replayed simultaneously with the second terminal, and streams the shared contents to the second terminal connected under the sharing environment, and the second terminal streamingly receives the shared contents from the first terminal connected under the sharing environment.

Preferably, the first terminal monopolizes rights of playback control of the contents to be simultaneously replayed.

According to still another aspect of the invention, there is provided a contents simultaneous playback method of a terminal which shares and simultaneously replays contents with a neighboring terminal in a single wireless access point network, the method including the steps of: a) identifying an environment of the network; b) broadcasting information of the terminal and searching neighboring terminals having the same configuration belonging to the network environment through the information broadcast in the same manner; c) setting a sharing environment for simultaneous playback of the contents with the neighboring terminals and requesting one selected from the searched neighboring terminals to allow access to the selected neighboring terminal or allowing the selected neighboring terminal to access the terminal; d) managing playback information of the contents shared and simultaneously replayed with the selected neighboring terminal; and e) streaming the shared contents to the selected neighboring terminal connected under the sharing environment.

According to still another aspect of the invention, there is provided a contents simultaneous playback method of a terminal which shares and simultaneously replays contents with a neighboring terminal in a single wireless access point network, the method including the steps of: a) identifying an environment of the network; b) broadcasting information of the terminal and searching neighboring terminals having the same configuration belonging to the network environment through the information broadcast in the same manner; c) setting a sharing environment for simultaneous playback of the contents with the neighboring terminals and requesting one selected from the searched neighboring terminals to allow access to the selected neighboring terminal or allowing the selected neighboring terminal to access the terminal; and d) streamingly receiving and replaying the shared contents from the selected neighboring terminal connected under the sharing environment.

According to an embodiment of the present invention, a contents simultaneous playback terminal, system and method is capable of allowing both terminals to share and simultaneously replay contents in a one-to-one correspondence by identifying terminals through terminal information broadcast in a single wireless access point network environment and setting a sharing environment for simultaneous playback of the contents of both terminals, without requiring a complicated separate sharing procedure.

According to an embodiment of the present invention, a contents simultaneous playback terminal, system and method is capable of simultaneously contents through a simple sharing procedure of identification of a network environment and search and selection of neighboring terminals, without a separate management server required for contents sharing and terminal identification.

According to an embodiment of the present invention, a contents simultaneous playback terminal, system and method is capable of, when both terminals connected in a one-to-one correspondence share contents, streaming the contents from one terminal to the other terminal and receiving in the other terminal the streamed contents for simultaneous playback of the contents, thereby extinguishing the contents after the playback.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a view showing a conventional situation where users enjoy the same contents;

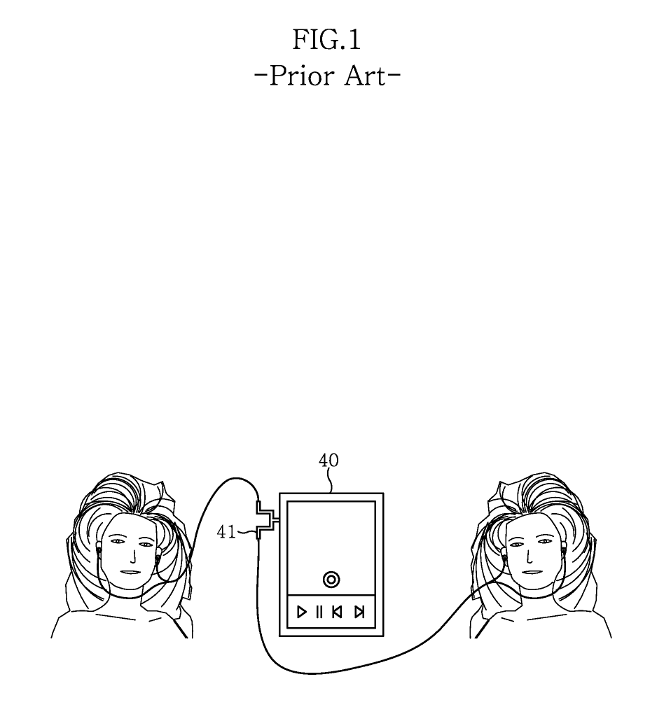

FIG. 2 is a view showing a general contents sharing system;

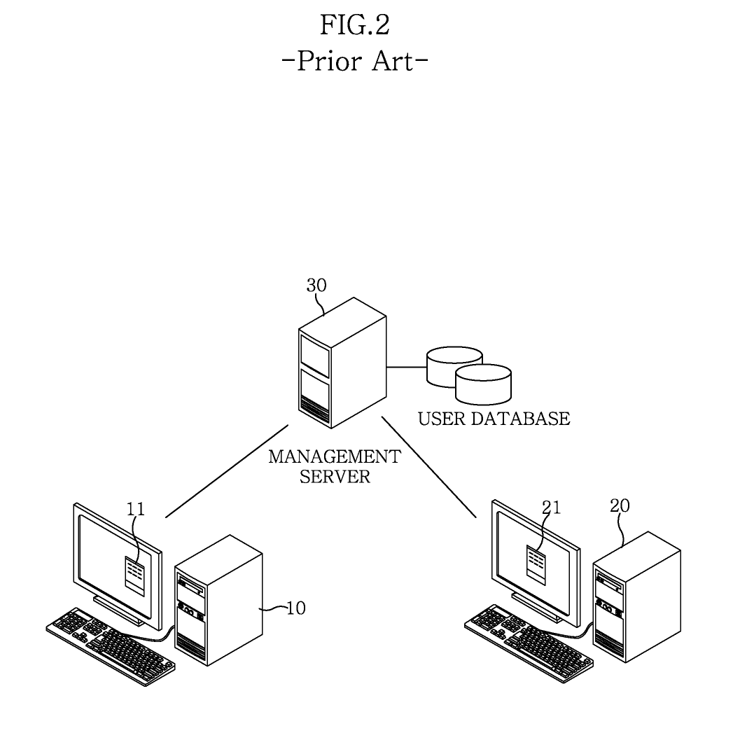

FIG. 3 is a view showing an example of contents sharing and simultaneous playback according to one embodiment of the present invention;

FIG. 4 is a view showing a configuration of a contents simultaneous playback system according to one embodiment of the present invention;

FIG. 5 is a view showing an example of network identification according to one embodiment of the present invention;

FIG. 6 is a view showing a first example of contents simultaneous playback according to one embodiment of the present invention;

FIG. 7 is a view showing a second example of contents simultaneous playback according to one embodiment of the present invention;

FIG. 8 is a first flow chart showing contents simultaneous playback according to one embodiment of the present invention; and

FIG. 9 is a second flow chart showing contents simultaneous playback according to one embodiment of the present invention.

### DETAILED DESCRIPTION OF THE PREFERRED EMBODIMENT

Embodiments of the present invention will be now described in detail with reference to the accompanying drawings.

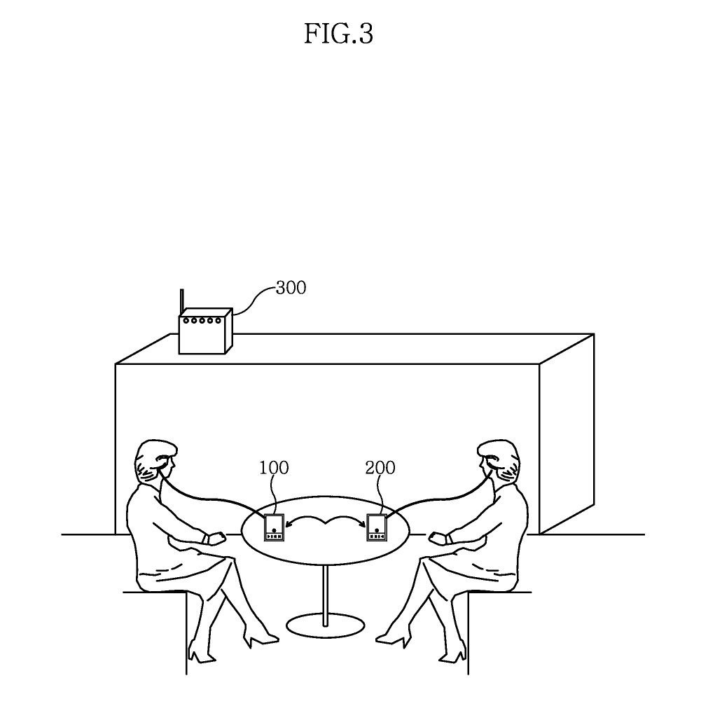

FIG. 3 is a view showing an example of contents sharing and simultaneous playback according to one embodiment of the present invention, showing a contents simultaneous playback system in which neighboring users use their respective user terminals 100 and 200 to simultaneously playback and enjoy contents stored in one of the terminals 100 and 200.

As shown in the figure, the contents simultaneous playback system includes two terminals 100 and 200 in a single wireless access point (AP) 300 network environment.

The terminals 100 and 200 broadcast their respective access information in the network environment. Any terminal 100 searches the neighboring terminal 200 having the same configuration in the network environment 300 through the broadcast access information and shares its contents with the neighboring terminal 200 for simultaneous playback in a one-to-one correspondence.

The terminal 100 sets a sharing environment for the contents simultaneous playback with the neighboring terminal 200.

Thereafter, the terminal 100 requests the neighboring terminal 200 to allow access to the neighboring terminal 200 or allows the neighboring terminal 200 to access the terminal 100.

A user of the terminal 100 and a user of the neighboring terminal 200 can playback the contents simultaneously by installing an application having functions of access, sharing environment setting and allowance and simultaneous playback.

Accordingly, the terminal 100 and the neighboring terminal 200 are preferably terminals such as smart phones which are capable of installing such an application and identifying wireless network environments, but may be any types of devices as long as they can identify wireless network environments and install applications.

The contents sharing system uses terminal information broadcast in the environment 300 within a single wireless network coverage to identify the neighboring terminal 200 and manage the access and simultaneous playback between the terminals 100 and 200. Accordingly, the system has an advantage of high convenience of contents sharing in neighboring environments without requiring a separate management server.

That is, the terminal 100 manages playback information of the contents to be shared with the neighboring terminal 200 and replayed simultaneously, and streams the shared contents to the neighboring terminal 200 connected under the sharing environment for simultaneous playback with the neighboring terminal 200.

In addition, the neighboring terminal 200 receives and replays a stream of the shared contents from the terminal 100 connected under the sharing environment.

The streaming is to divide a large file into smaller files for transmission for real time playback. Since the terminal 100 to transmit the contents streams the contents unilaterally to the neighboring terminal to receive and replay the contents, simultaneous playback synchronization can be guaranteed with little or no error.

In this case, the terminal 100 may set the sharing environment such that it monopolizes rights of playback control of the contents to be simultaneously replayed.

In addition, since the terminals 100 and 200 broadcast their respective information in the single wireless access point 300 network environment and search neighboring terminals having the same configuration according to the same scheme, it is very easy to distinguish between the terminals 100 and 200 in the network.

As described above, such a content simultaneous playback function may be distributed using an application applied to a smart phone or pad to support wireless LAN communication.

In this way, the contents simultaneous playback system is convenient in that the system is capable of allowing the terminal 100 and the neighboring terminal 200 to share and simultaneously replay the contents in a one-to-one correspondence by identifying neighboring terminals through terminal information broadcast in the single wireless access point 300 network environment and setting the sharing environment for simultaneous playback of the contents of both terminals 100 and 200, thereby allowing users to immediately enjoy the same contents between both terminals 100 and 200, without requiring a complicated separate sharing procedure.

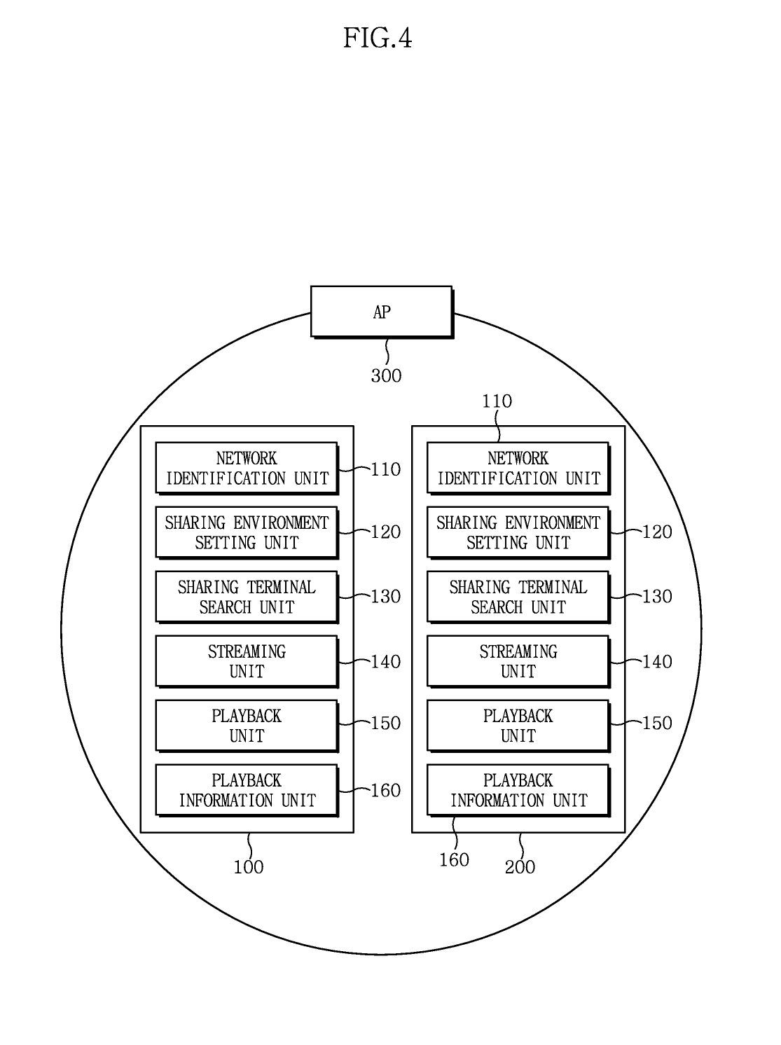

FIG. 4 is a view showing a configuration of the contents simultaneous playback system including the terminals 100 and 200 to share and simultaneously replay the contents in the single wireless access point 300 network environment shown in FIG. 3, according to one embodiment of the present invention.

The terminal 100 is a terminal 100 to share and simultaneously replay the contents with the neighboring terminal 200 in the single wireless access point 300 network environment. The terminal 100 includes a network identification unit 110 which identifies the network environment, a sharing terminal search unit 130 which broadcasts its own information and searches neighboring terminals having the same configuration belonging to the network environment through the broadcast information according to the same scheme, a sharing environment setting unit 120 which sets a sharing environment for simultaneous playback of the contents with the neighboring terminal 200, and requests the neighboring terminal 200 to allow access to the neighboring terminal 200 or allows the neighboring terminal 200 to access the terminal 100, a playback information unit 160 which manages playback information of the contents shared with the neighboring terminal 200 and replayed simultaneously, a streaming unit 140 which streams the shared contents to the neighboring terminal 200 connected under the sharing environment, and a playback unit 150 which receives the shared contents from the neighboring terminal 200 connected under the sharing environment in a streaming manner or replays the contents transmitted by the streaming unit 140.

The sharing terminal search unit 130 selects the neighboring terminal 200 by distinguishing one or more neighboring terminals 200 belonging to the network environment based on identifiers, preferably, their IP addresses.

The contents simultaneous playback system can be very conveniently used for contents sharing between both terminals 100 and 200 since both terminals 100 and 200 in the single wireless access point 300 can share and simultaneously replay the contents through the playback unit contained in the terminal 100 without a separate management server required for contents sharing and simultaneous playback.

The sharing environment setting unit 120 sets the sharing environment to be divided into a master mode and a slave mode. If the terminal 100 is in the master mode, the streaming unit 140 streams the shared contents to the neighboring terminal 200 connected under the sharing environment. If the terminal 100 is in the slave mode, the playback unit 150 receives the shared contents from the neighboring terminal 200 connected under the sharing environment in a streaming manner.

That is, the terminal 100 providing the contents is set in the master mode to unilaterally transmit the contents to the neighboring terminal 200 which then receives and replays the contents intactly.

Accordingly, users of the terminals 100 and 200 can enjoy the same contents stored in the terminal 100 through their respective terminals 100 and 200 in the same place without using only the same terminal 100 together.

The terminals 100 and 200 streamingly replay the shared contents simultaneously in a one-to-one correspondence and the shared contents become extinct after the playback, which does not raise any legal problem such as copyright infringement.

Accordingly, if the terminal 100 is in the master mode, it is more preferable to allow the sharing environment setting unit 120 to monopolize rights of playback control of the contents to be simultaneously replayed and to allow the neighboring terminal 200 to merely enjoy the received contents.

In addition, the terminals 100 and 200 have an advantage in that the contents are simultaneously replayed through a simple sharing procedure of identification of network environments and search and selection of neighboring terminals without a separate management server required for the content sharing and terminal identification, and synchronization of the simultaneous playback is improved to make the contents sharing and simultaneous playback between the terminals 100 and 200 very easy.

In addition, as the playback unit 150 is implemented by a format of application and the sharing environment setting unit 120 includes a contents user interface to allow a user to select the shared contents, a user of the terminal 100 storing the contents can simultaneously replay only the selected contents with the neighboring terminal 200.

Examples of the shared contents may include music, moving picture, movie and any contents as long as they can be replayed.

In addition, the playback information unit 160 preferably manages playback link information of the contents or a stored contents file as playback information of the contents.

That is, when the terminal 100 transmits the contents to the neighboring terminal 200, the terminals 100 and 200 can share and enjoy contents of a sound source site in which the terminal 10 joins as a membership, in addition to the stored contents.

For example, the terminal 100 preferably accesses the sound source site to select the playback link information of the contents, and transmits the selected contents being replayed to the neighboring terminal 200 in real time.

In addition, the playback information unit 160 may further include and manage additional playback information of the contents, such as title, singer and playback time, as the playback information of the contents.

In this way, in the contents simultaneous playback system, when the terminals 100 and 200 connected in a one-to-one correspondence share the contents, since the terminal 100 streams the contents to the neighboring terminal 200, the neighboring terminal 200 receives the streamed contents for simultaneous playback of the contents, and the contents become extinct after the playback, it is possible to prevent the contents from being embroiled in a legal dispute of infringement of copyright.

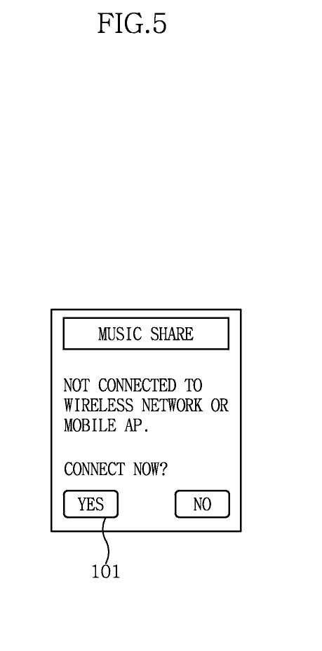

FIG. 5 is a view showing an example of network identification according to one embodiment of the present invention. FIG. 5 shows a user interface provided to identify a single network environment in a terminal.

A user sets a network environment by selecting “YES” 101 to identify the network environment and use a wireless network in the identified environment.

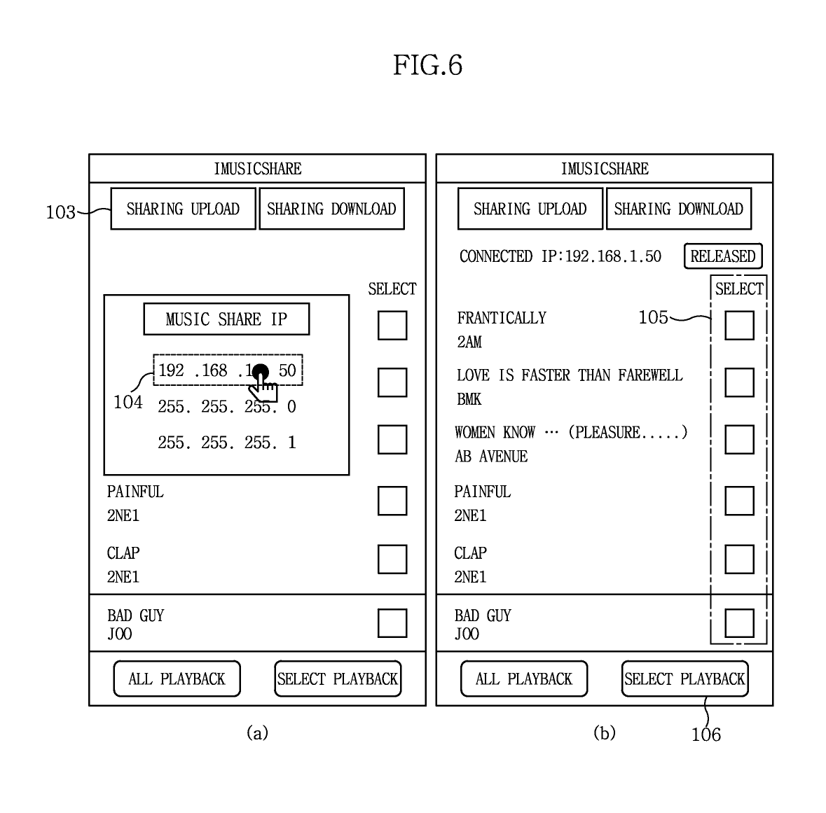

FIG. 6 is a view showing a first example of contents simultaneous playback according to one embodiment of the present invention. FIG. 6 shows a user interface of a terminal to share stored contents.

Referring to FIG. 6a, when a user of a terminal to transmit contents selects “sharing upload” 103, IP addresses of neighboring terminals to receive the contents in the single network environment are provided as a pop up window.

The user selects 104 from the pop up window an IP address of a neighboring terminal which wishes to receive the contents.

Referring to FIG. 6b, when the user selects 105 the contents to be shared from the stored contents and clicks on a selection playback button 106, the selected contents are transmitted to the selected neighboring terminal.

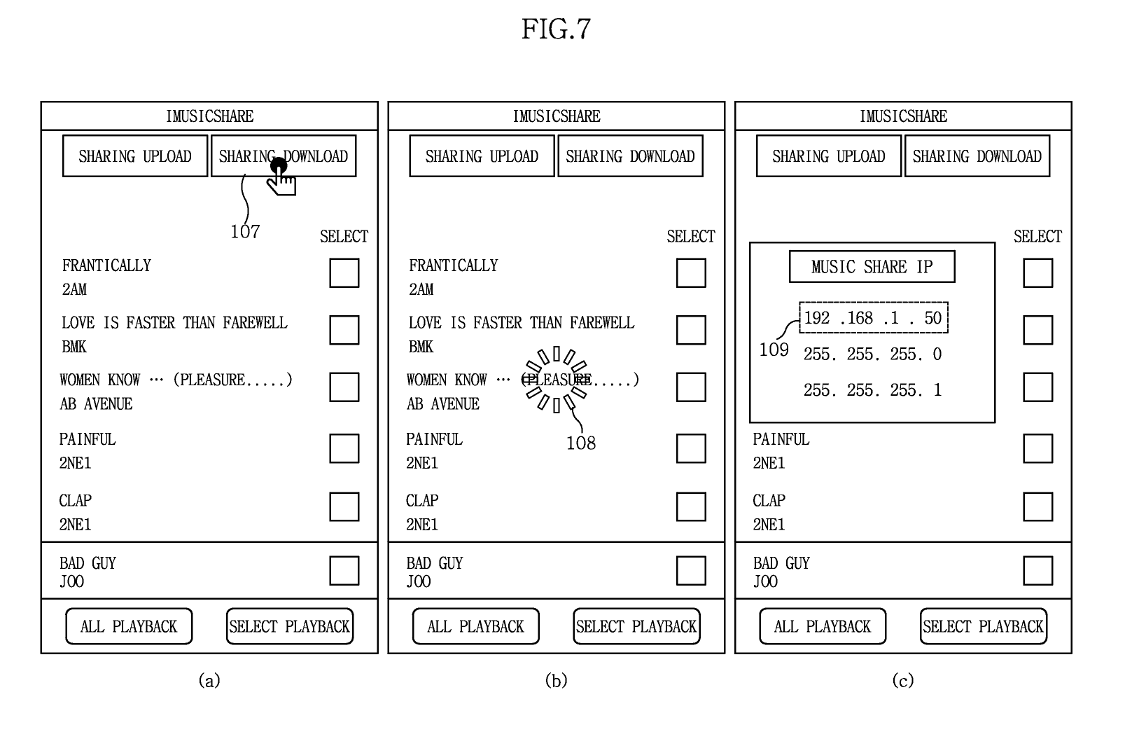

FIG. 7 is a view showing a second example of contents simultaneous playback according to one embodiment of the present invention. The FIG. 7 shows a user interface of a neighboring terminal which wishes to receive contents from a terminal which wishes to share the contents in the single network environment.

Referring to FIG. 7a, a user of the neighboring terminal which wishes to receive the contents to be simultaneously replayed selects “sharing download” 107.

Referring to FIG. 7b, the neighboring terminal searches 108 terminals which can be selected in the single wireless network.

Referring to FIG. 7c, a pop up window listing IP addresses of the searched terminals is displayed on a screen of the neighboring terminal and, when the user of the neighboring terminal selects 109 from the pop up window a terminal which wishes to simultaneously replay the contents, the contents can be simultaneously replayed and enjoyed in both terminals.

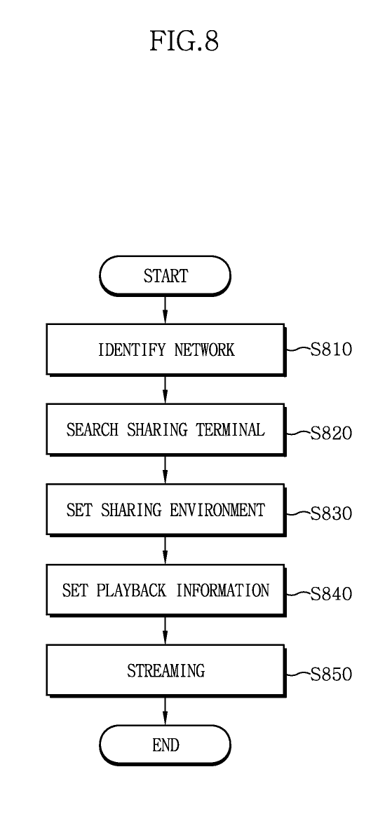

FIG. 8 is a first flow chart showing contents simultaneous playback according to one embodiment of the present invention. FIG. 8 shows a simultaneous playback method of a terminal which transmits contents.

The contents simultaneous playback method of a terminal which shares and simultaneously replays contents with a neighboring terminal in a single wireless access point network includes the steps of: identifying an environment of the network (S810), broadcasting information of the terminal and searching neighboring terminals having the same configuration belonging to the network environment through the information broadcast in the same manner (S820), setting a sharing environment for simultaneous playback of the contents with the neighboring terminals and requesting one selected from the searched neighboring terminals to allow access to the selected neighboring terminal or allowing the selected neighboring terminal to access the terminal (S830), managing playback information of the contents shared and simultaneously replayed with the selected neighboring terminal (S840), and streaming the shared contents to the selected neighboring terminal connected under the sharing environment (S850).

In the contents streaming step (S850), the terminal may monopolize rights of playback control of the contents to be simultaneously replayed.

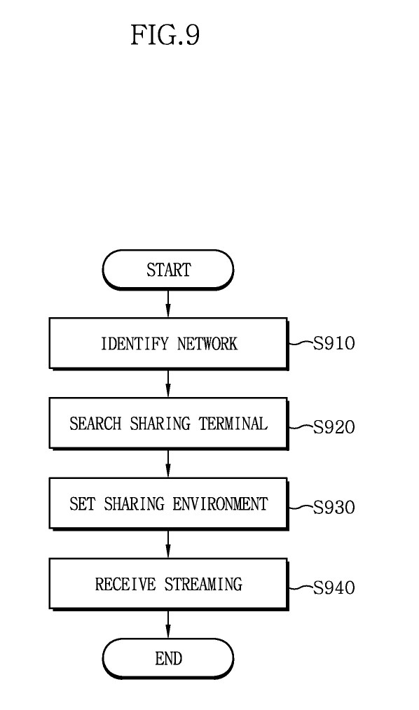

FIG. 9 is a second flow chart showing contents simultaneous playback according to one embodiment of the present invention. FIG. 9 shows a contents simultaneous playback method of a neighboring terminal which receives contents in a streaming manner and simultaneously replays the received contents.

The contents simultaneous playback method of a terminal which shares and simultaneously replays contents with a neighboring terminal in a single wireless access point network includes the steps of: identifying an environment of the network (S910), broadcasting information of the terminal and searching neighboring terminals having the same configuration belonging to the network environment through the information broadcast in the same manner (S920), setting a sharing environment for simultaneous playback of the contents with the neighboring terminals and requesting one selected from the searched neighboring terminals to allow access to the selected neighboring terminal or allowing the selected neighboring terminal to access the terminal (S930), and streamingly receiving and replaying the shared contents from the selected neighboring terminal connected under the sharing environment (S940).

While the present invention has been particularly shown and described with reference to exemplary embodiments thereof, it will be understood by those skilled in the art that various changes in form and details may be made therein without departing from the spirit and scope of the present invention. The exemplary embodiments are provided for the purpose of illustrating the invention, not in a limitative sense. Thus, it is intended that the present invention covers the modifications and variations of this invention provided they come within the scope of the appended claims and their equivalents.

What is claimed is:

1. A contents simultaneous playback terminal which shares and simultaneously replays contents with a neighboring terminal in a single wireless access point network, comprising:
a network identification unit which identifies an environment of the network;
a sharing terminal search unit which broadcasts its own information and searches neighboring terminals having the same configuration belonging to the network environment through the broadcast information according to the same scheme;
a sharing environment setting unit which sets a sharing environment for simultaneous playback of the contents with the neighboring terminals, and requests one selected from the searched neighboring terminals to allow access to the selected neighboring terminal or allows the selected neighboring terminal to access the terminal;
a playback information unit which manages playback information of the contents shared and replayed simultaneously with the selected neighboring terminal;
a streaming unit which streams the shared contents to the selected neighboring terminal connected under the sharing environment; and
a playback unit which streamingly receives the shared contents from the neighboring terminal connected under the sharing environment or replays the contents transmitted by the streaming unit.

2. The contents simultaneous playback terminal according to claim 1, wherein the sharing environment setting unit sets the sharing environment to be divided into a master mode and a slave mode,
if the terminal is in the master mode, the streaming unit streams the shared contents to the neighboring terminal connected under the sharing environment, and
if the terminal is in the slave mode, the playback unit streamingly receives and replays the shared contents from the neighboring terminal connected under the sharing environment.

3. The contents simultaneous playback terminal according to claim 2, wherein, if the terminal is in the master mode, the sharing environment setting unit monopolizes rights of playback control of the contents to be simultaneously replayed.

4. The contents simultaneous playback terminal according to claim 1, wherein the playback information unit manages playback link information of the contents or a stored contents file as playback information of the contents.

5. The contents simultaneous playback terminal according to claim 1, wherein the playback information unit further includes and manages additional playback information of the contents, such as title, singer and playback time, as the playback information of the contents

6. The contents simultaneous playback terminal according to claim 1, wherein the sharing terminal search unit distinguishes one or more neighboring terminals belonging to the network environment based on IP addresses.

7. The contents simultaneous playback terminal according to claim 1, wherein the playback unit is implemented by a format of application.

8. The contents simultaneous playback terminal according to claim 1, wherein the sharing environment setting unit further includes a contents user interface to allow a user to select the shared contents.

9. The contents simultaneous playback terminal according to claim 1, wherein the shared contents are one of music, moving picture and movie.

10. A contents simultaneous playback system which searches one or more neighboring terminals belonging to an environment of a single wireless access point network and shares and simultaneously replays contents with one selected from the searched neighboring terminals, comprising:
first and second terminals which broadcast their own information, search neighboring terminals having the same configuration belonging to the network environment through the broadcast information according to the same scheme, set a sharing environment for simultaneous playback of the contents with the neighboring terminals, and request the selected neighboring terminal to allow access to the selected neighboring terminal or allows access of the selected neighboring terminal,
wherein the first terminal manages playback information of the contents shared and replayed simultaneously with the second terminal, and streams the shared contents to the second terminal connected under the sharing environment, and
the second terminal streamingly receives the shared contents from the first terminal connected under the sharing environment.

11. The contents simultaneous playback system according to claim 10, wherein the first terminal monopolizes rights of playback control of the contents to be simultaneously replayed.

12. A contents simultaneous playback method of a terminal which shares and simultaneously replays contents with a neighboring terminal in a single wireless access point network, the method comprising the steps of:
a) identifying an environment of the network;
b) broadcasting information of the terminal and searching neighboring terminals having the same configuration belonging to the network environment through the information broadcast in the same manner;
c) setting a sharing environment for simultaneous playback of the contents with the neighboring terminals and requesting one selected from the searched neighboring terminals to allow access to the selected neighboring terminal or allowing the selected neighboring terminal to access the terminal;
d) managing playback information of the contents shared and simultaneously replayed with the selected neighboring terminal; and
e) streaming the shared contents to the selected neighboring terminal connected under the sharing environment.

13. A contents simultaneous playback method of a terminal which shares and simultaneously replays contents with a neighboring terminal in a single wireless access point network, the method comprising the steps of:
a) identifying an environment of the network;
b) broadcasting information of the terminal and searching neighboring terminals having the same configuration belonging to the network environment through the information broadcast in the same manner;
c) setting a sharing environment for simultaneous playback of the contents with the neighboring terminals and requesting one selected from the searched neighboring terminals to allow access to the selected neighboring terminal or allowing the selected neighboring terminal to access the terminal; and
d) streamingly receiving and replaying the shared contents from the selected neighboring terminal connected under the sharing environment.
